(19) United States
(12) Patent Application Publication
(10) Pub. No.: US 2023/0039737 A1
(43) Pub. Date: Feb. 9, 2023

(54) STUFFED PACIFIER FOR ANIMALS

(71) Applicant: Sherry Sorenson, SANDY, OR (US)

(72) Inventor: Sherry Sorenson, SANDY, OR (US)

(21) Appl. No.: 17/586,722

(22) Filed: Jan. 27, 2022

Related U.S. Application Data
(60) Provisional application No. 63/229,456, filed on Aug. 4, 2021.

(51) Int. Cl. A01K 15/02

(52) U.S. Cl. CPC A01K 15/026

(57) ABSTRACT

A stuffed pacifier for an animal that can be chewed by the animal to satisfy an urge to chew. The stuffed pacifier includes a body configured to be chewed by an animal and a strap fastened to a bottom surface of the body forming loop. The loop can be hung from a collar of the animal.

### CROSS-REFERENCE TO RELATED APPLICATIONS

This application claims priority from the U.S. provisional patent application Ser. No. 63/229,456, filed on Aug. 4, 2021, which is incorporated herein by reference in its entirety.

### FIELD OF INVENTION

The present invention relates to a chew toy for animals, and more particularly, the present invention relates to a stuffed animal chew or pacifier.

### BACKGROUND

Dogs have emotions, however, due to the lack of verbal communication, the dogs cannot inform about their emotions to humans. Nibbling, gentle chewing or mouthing are some of the signs performed by the dogs for gaining attention. Certain health or environmental conditions can make the dogs more anxious which leads to uncontrolled chewing, nibbling, or nipping. The dogs can show signs such as a continuous urge to bite on something or chewing the leash. Certain dogs may develop a habit to chew most of the time. An unsatisfied urge to chew can make the dogs become aggressive and unmanageable. It is not uncommon that an aggressive dog accidentally nips a person.

Thus, a need is appreciated for a utility article that can be used by dogs to satisfy their urge to chew.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a stuffed pacifier that can be chewed by animals to satisfy their urge to chew.

It is another object of the present invention that animal does not nip people because of their urge to chew.

It is still another object of the present invention that the stuffed pacifier prevents the animals from getting aggressive.

It is yet another object of the present invention that the stuffed pacifier can prevent the animals from chewing the leash.

It is a further object of the present invention that the stuffed pacifier can prevent the animals from nibbling on clothing.

In one aspect, disclosed is a stuffed pacifier that can be used by animals to satisfy their urge to chew. The stuffed pacifier can include an enclosure of a shape resembling an animalistic figure, astronomical body, flower, cartoon characters, and the like.

In one aspect, disclosed is a stuffed pacifier for an animal, the stuffed pacifier includes a body configured to be chewed by an animal; and a strap having a first end and an opposite second end, wherein the first end and the second end are fastened to a bottom surface of the body to form a loop, the loop configured to be hung from a collar of the animal. The strap can be stitched to the body. The body can include an enclosure made from a flexible material and of a predetermined shape and a stuffing encased within the enclosure. The flexible material can be a fabric that is inert. The enclosure and the strap are made from the same material. In one implementation, the predetermined shape resembles an animalistic figurine, an astronomical body, or a flower.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 shows an exemplary embodiment of the stuffed pacifier, according to an exemplary embodiment of the present invention.

### DETAILED DESCRIPTION

The accompanying figures, which are incorporated herein, form part of the specification and illustrate embodiments of the present invention. Together with the description, the figures further explain the principles of the present invention and to enable a person skilled in the relevant arts to make and use the invention.

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

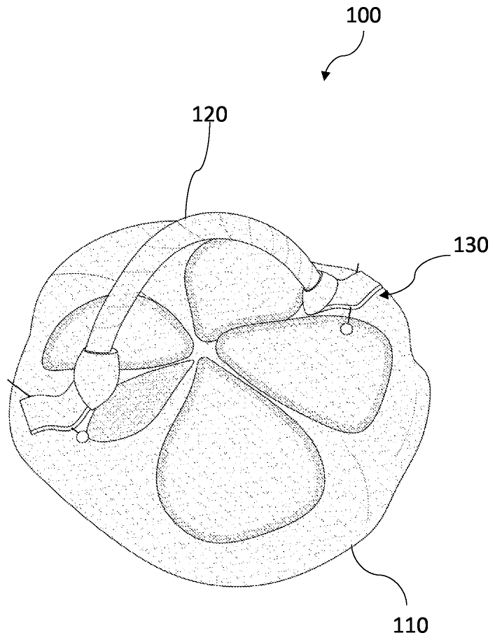

Referring to FIG. 1 which shows an exemplary embodiment of the disclosed stuffed pacifier 100 of a flower shape. The stuffed pacifier 100 can be manufactured in different shapes, colors, and designs, such as daisies. The stuffed pacifier 100 can be hung from the collar of the animal and positioned to be within the reach of the mouth of the animal. The animals can chew the disclosed stuffed pacifier as and when desired to satisfy their urge to chew. The stuffed pacifier 100 can include a body 110 and a strap 120 coupled at its two ends to a bottom face of the body 110 to form a loop. The body 110 can be for chewing by the animal while the strap can allow the stuffed pacifier 100 to be hung from a collar of the animal. A fastening member can couple the strap 120 to a collar worn by an animal around their neck. The fastening member can be a clip, such as a carbineer that may allow mounting and unmounting the stuffed pacifier to the collar as and when desired. Any other fastening member can be used in place of the clip and any type of clip can be used known to a skilled person for hanging an article from a collar or band, and any such fastening member or clip is within the scope of the present invention.

The body 110 can include an enclosure 130 made from a flexible material, such as a fabric. The fabric should be inert and safe such that it may not cause any harm to animals chewing the stuffed pacifier. Moreover, the material should provide sufficient puncture resistance against sharp teethes of the animals. The enclosure can be manufactured in different shapes and sizes, such as animalistic figures, astronomical bodies, flowers, cartoon characters, and the like. The strap 120 and the body 110 can be made from the same material or different materials. The strap 120 can be bonded to an outer surface of the enclosure through a variety of mechanisms, such as stitching and bonding.

Enclosure 130 can be filled with stuffing (not shown) to provide a volume to the flexible enclosure. The stuffing could be made from material that can be safe for animals and inert. In case, the stuffing comes in contact with the animal, or the stuffing is exposed, the same may not cause any harm to the animal if chewed by the animal. Moreover, the stuffing can be present as an integral single unit or multiple units, wherein a single unit can be such that it cannot be swallowed by the animal because of the large size or volume of the single unit of stuffing.

The disclosed stuffed pacifier can also include an attached cover that can be rolled over the body of the stuffed pacifier for storage and can be unrolled to expose the body of the stuffed pacifier for use by the animal. The cover can be attached at a suitable position on the body or the strap, such that to not interfere with chewing the stuffed pacifier. For example, the cover can be attached nearby the attachment for the strap. In use, the disclosed stuffed pacifier can be unhooked from the collar of the animal, and then the cover can be rolled over the body of the stuffed pacifier, and the stuffed pacifier with the covered body can be attached to the leash of the animal. The animal can preferably be a dog, however, any pet is within the scope of the present invention.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A stuffed pacifier for an animal, the stuffed pacifier comprises:
a body configured to be chewed by an animal; and
a strap having a first end and an opposite second end, wherein the first end and the second end are fastened to a bottom surface of the body to form a loop, the loop configured to be hung from a collar of the animal.

2. The stuffed pacifier according to claim 1, wherein the strap is stitched to the body.

3. The stuffed pacifier according to claim 1, wherein the body comprises:
an enclosure made from a flexible material and of a predetermined shape; and
a stuffing encased within the enclosure.

4. The stuffed pacifier according to claim 3, wherein the flexible material is a fabric that is inert.

5. The stuffed pacifier according to claim 4, wherein the enclosure and the strap are made from the same material.

6. The stuffed pacifier according to claim 3, wherein the predetermined shape resembles an animalistic figurine.

7. The stuffed pacifier according to claim 3, wherein the predetermined shape resembles an astronomical body.

8. The stuffed pacifier according to claim 3, wherein the predetermined shape resembles a flower.
